(19) United States
(12) Patent Application Publication
(10) Pub. No.: US 2003/0182406 A1
(43) Pub. Date: Sep. 25, 2003

(54) "Method for the installation of a license code"

(75) Inventors: Jochen Dick, Uttenreuth (DE); Uwe Folkers, Aurich (DE); Dirk Weseloh, Erlangen (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/389,893

(22) Filed: Mar. 17, 2003

(30) Foreign Application Priority Data
Mar. 20, 2002 (DE) 10212411.6

(51) Int. Cl. G06F 17/60; G06F 15/177; G06F 9/44

(52) U.S. Cl. 709/221; 705/51; 717/171

(57) ABSTRACT

In a method for the installation of a license code, an e-mail is communicated to a first computer. As an attachment, the e-mail includes an executable computer program that includes license code and an installation routine allocated to the license code. The executable computer program is a self-extracting archive that extracts the license code and the installation routine given an execution of the executable computer program. The license code is provided for enabling at least one program routine installed on a second computer. The installation routine is provided for configuring the second computer with the license code such that the license code enables the installed program routine.

### BACKGROUND OF THE INVENTION

1. Field of the Invention

The present invention is directed to methods for the installation of a license code.

2. Description of the Prior Art

Occasionally, computers are configured with a computer program containing at least one program routine that is not available for a user. To allow the user to use the unavailable program routine, this routine must be enabled with a license code. A license code is a code word with which the computer is configured.

The computer can be configured, for example, such that an existing license code file is modified with the new license code, so that the program routine allocated to the new license code is available to the user. It may be necessary, however, to execute a number of manual steps in order to suitably configure the computer. It may also be necessary for the vendor of the program routine to be enabled to dispatch a specially trained technician to the user's computer, and this technician configures the user's computer with the license code.

After the configuration of the computer with the license code, the program routine allocated to the license code is available to the user, i.e. the user can use the application allocated to the program routine. In order to use the newly available program routine in an adequate way, it may be necessary for the user to be properly trained by an employee of the vendor of the program routine.

### SUMMARY OF THE INVENTION

It is an object of the invention to provide a method that allows an easier installation of a program code.

This object is achieved in a method for the installation of a license code in accordance with the invention wherein an e-mail is communicated to a first computer, the e-mail including an executable computer program that has a license code and an installation routine allocated to the license code as attachments; the executable computer program functioning as a self-extracting archive that extracts the license code and the installation routine given an execution of the executable computer program. The license code is provided for enabling at least one program routine installed on a second computer, and the installation routine is provided for configuring the second computer with the license code such that the license code enables the installed program routine.

Inventively, the e-mail communicated to the first computer contains the executable computer program, which functions as a self-extracting archive, as an attachment. An executable computer program is a *.exe program. The executable program has the license code and the installation routine allocated to the license code. The license code is provided for enabling at least one program routine with which the second computer is already configured. Without the installed license code, the application allocated to the program routine cannot be executed with the second computer.

The installation routine allocated to the license code is provided for automatically configuring the second computer as soon as the installation routine is executed.

The license code and the installation routine allocated to it are automatically extracted by the execution of the executable computer program. The executable program can be executed with the first computer, the second computer or with another computer. In a preferred embodiment of the invention, the executable computer program is executed, however, with the first computer, so that the license code and the installation routine can be stored on a diskette in the course of the execution. In a version of the invention, the diskette can be inserted into a disk drive allocated to the second computer, and the second computer can be configured with the license code by executing the installation routine with the second computer.

After the license code and the installation routine allocated to it have been extracted from the executable computer program, the second computer can be configured with the license code by executing the installation routine allocated to the license code is executed. Subsequently, the installation routine automatically configures the second computer with the license code, so that the program routine that is allocated to the license code is enabled.

If it is not possible for an executable program to be received as attachment by the first computer because, for example, the first computer is protected with a firewall, then according to a version of the invention the e-mail additionally includes the license code as text datafile and a description for the configuration of the second computer with the license code. When, for example, the first computer is protected with the firewall, it may be that the firewall automatically deletes executable computer programs joined to an e-mail as an attachment and forwards the e-mail to the first computer without the attachment. In this case, the user of the second computer receives at least the license code and a description for the configuration of the second computer with the license code communicated to the user's first computer. In this case, however, the user must manually configure the second computer with the license code.

In order for the user of the first computer and the second computer to have the license code communicated to the first computer, the user can request the communication of the e-mail via the Internet in an embodiment of the invention.

After the user has configured the second computer with the license code, it may be necessary for the user to learn the application of the enabled program routine. For this purpose, in a preferred embodiment of the invention, the e-mail includes an address of a World Wide Web (WWW) page that contains a description for the application of the program routine enabled with the license code.

The above object is also achieved in a method for installing a license code in accordance with the invention wherein an e-mail is received with a first computer, the e-mail having a self-extracting computer program as an attachment that includes a license code and an installation routine allocated to the license code, the self-extracting computer program is executed with the first computer, so that the license code and the installation routine are extracted, the license code and the installation program are communicated to a second computer that is configured with at least one program routine that can be enabled with the license code, and the installation routine is executed with the second computer, so that the installation routine configures the second computer with the license code such that the license code enables the program routine.

In the second embodiment of the inventive method the e-mail, which includes the self-extracting computer program as an attachment, is received with the first computer. The self-extracting computer program is a *.exe program. The self-extracting computer program includes the license code and the installation routine allocated to the license code. The license code is provided so that the second computer can be configured with it so that at least one program routine that is installed on the second computer, and that is not yet available to a user, is enabled. Inventively, the self-extracting computer program is executed with the first computer such that the license code and the installation routine are extracted. Subsequently, the second computer is configured with the license code with the assistance of the installation routine.

The inventive method can lower process costs. Costs for acquisition, installation and training for the user can be reduced on the basis of the inventive method.

The program routine allocated to the license code also can be temporarily available to the user. Such demo licenses thus can be made available relatively economical on the basis of the inventive method, as a result of which it may be possible for the vendor of the license code to sell a number of time-unlimited license codes.

The delivery time for supplying the license code also can be shortened by the inventive method since the license code is sent with an e-mail, and the user can install the license code in a relatively simple way without assistance. The vendor of the license code therefore need not make any employees available for training the user.

### DESCRIPTION OF THE DRAWINGS

FIG. 1 is a scenario that illustrates the inventive methods.

FIG. 2 shows a structure of a self-extracting computer program that has a license code and an installation routine.

### DESCRIPTION OF THE PREFERRED EMBODIMENTS

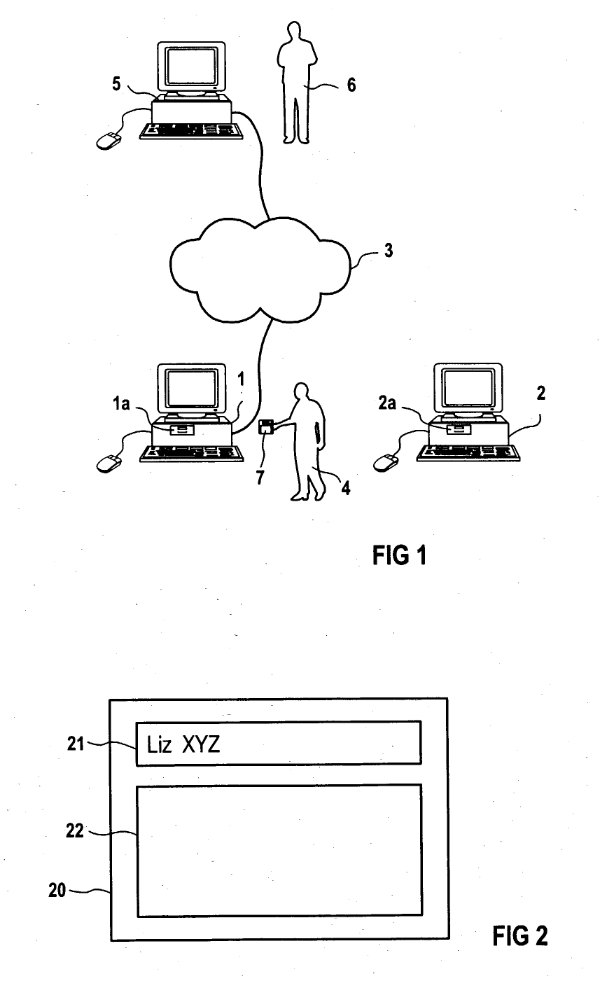

FIG. 1 shows a first computer 1 connected to the Internet 3 and a second computer 2. In the exemplary embodiment, the second computer 2 is not connected to the Internet 3. The first computer 1 and the second computer 2 belong to a user 4 in the present exemplary embodiment. The second computer 2 is configured with a number of computer programs. In the exemplary embodiment, one of these computer programs has a number of program routines, at least one of which is not available to the user. The user 4, however, has the possibility of enabling the non-enabled program routines by means of a license code that the user can order from the vendor of the computer program.

In the exemplary embodiment, the user 4 can request the license code via the Internet 3. For this purpose, the user uses the first computer 1 to download a WWW-page (not shown in the figures) that is allocated to the vendor of the computer program. In the exemplary embodiment, the WWW-page is stored in an Internet server 5 that is operated by the vendor of the computer program and connected to the Internet 3. The WWW-page comprises a suitable order form for requesting the license code.

As a result of the order, an employee 6 of the vendor of the computer program sends an e-mail to the first computer 1 of the user 4. The e-mail includes an executable computer program 20, whose structure is schematically shown in FIG. 2, as an attachment. The computer program 20 has the requested license code 21 and an installation routine 22 allocated to the license code 21. The executable computer program 20 is a self-extracting archive, i.e. the license code 21 and the installation routine 22 are automatically extracted when it is executed.

In the exemplary embodiment, the executable computer program 20 is also implemented such that it prompts the user 4 to insert a diskette 7 into a disk drive 1a allocated to the first computer 1, so that the license code 21 and the installation routine 22 are stored on the diskette 7 after the user 4 has received the e-mail with the user's first computer 1 and executes the attached executable computer program 20.

After the license code 21 and the installation routine 22 are stored on the diskette 7, the user 4 removes the diskette 7 from the disk drive 1a allocated to the first computer 1 and places it into a disk drive 2a allocated to the second computer 2. Subsequently, the user 4 executes the installation routine 22 allocated to the license code 21 with the second computer 2, whereupon the installation routine 22 automatically configures the second computer 2 with the license code 21 such that the program routine allocated to the license code 21 is enabled. In the exemplary embodiment, the installation routine copies the license code into a license file of the computer program that is installed on the second computer 2 and allocated to the program routine, the license file being allocated for the enable of the program routine.

So that the user 4 can adequately use the program routine that has just been enabled, the user 4 requires suitable training in the exemplary embodiment. In the exemplary embodiment, the e-mail containing the computer program 20 to be executed has a link to a further WWW-page (not shown in the figures) of the vendor of the license code 21. The WWW-page includes a description for applying the program routine enabled with the license code 21.

In the exemplary embodiment, the e-mail communicated to the first computer 1 includes the executable computer program 20 as an attachment. It is also possible for the e-to mail additionally include the license code 21 as a text file and an instruction for the configuration of the second computer 2 with the license code 21. This, for example, is necessary when the first computer 1 is protected with a firewall that deletes automatically executable programs that are enclosed to an e-mail as an attachment.

In the exemplary embodiment, the user 4 extracts the license code 21 and the installation routine 22 allocated to the license code 21 from the executable computer program 20 with the first computer 1. The user 4 also can extract the license code 21 and the installation routine 22 with the second computer 2 or with a further computer. A storing of the license code 21 and of the installation routine 22 on the diskette 7 is also optional. In particular, the license code 21 and the installation routine 22 can be extracted with the first computer 1 and are communicated from the first computer 1 to the second computer 2 with, for example, an electrical line with which the first computer 1 and the second computer 2 are connected.

The second computer 2 also can be connected to the Internet 3.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for installing a license code, comprising the steps of:
formulating an e-mail for transmittal to a first computer with an attachment comprising an executable computer program, a license code and an installation routine allocated to the license code, said executable computer program comprising a self-extracting archive that extracts said license code and said installation routine upon execution of said executable computer program, said license code enabling at least one program routine installed at a second computer, and said installation routine being operable for configuring said second computer with said license code so that said license code enables said installed program routine; and
communicating said e-mail with said attachment to said first computer.

2. A method as claimed in claim 1 comprising executing said computer program at said first computer and storing said license code and said installation routine on a diskette during said execution at said first computer.

3. A method as claimed in claim 2 comprising transferring said diskette to a disk drive allocated to said second computer, and operating said second computer with said diskette to execute said installation routine to enable said at least one routine at said second computer with said license code.

4. A method as claimed in claim 1 comprising additionally including said license code in said e-mail as a text file and a description for configuring said second computer with said license code.

5. A method as claimed in claim 1 wherein the step of communicating said e-mail comprises communicating said e-mail upon request via the Internet.

6. A method as claimed in claim 1 comprising including an address of a web page in said e-mail that contains a description of said at least one program routine enabled by said license code.

7. A method for installing a license code, comprising the steps of:
receiving an e-mail with an attachment at a first computer, said attachment comprising a self-extracting computer program, a license code, and an installation routine allocated to said license code;
executing said self-extracting computer program at said first computer and thereby extracting said license code and said installation routine at said first computer;
communicating said license code and said installation routine from said first computer to a second computer, said second computer being configured with at least one program routine that is enableable by said license code; and
executing said installation routine at said second computer and thereby configuring said second computer with said installation routine and said license code so that said license code enables said at least one program routine in said second computer.

8. A method as claimed in claim 7 comprising storing said license code and said installation routine at a diskette at said first computer, and transferring said diskette from said first computer to a disk drive of said second computer for configuring said second computer with said installation routine and said license code.

9. A method as claimed in claim 7 comprising additionally including said license code in said e-mail as a text file and including a description in said e-mail for configuring said second computer with said license code.

10. A method as claimed in claim 7 comprising requesting said e-mail via the Internet.

11. A method as claimed in claim 7 comprising including in said e-mail an address of a web page containing a description of said at least one program routine enabled by said license code.
